(19) United States
(12) Patent Application Publication
(10) Pub. No.: US 2005/0041625 A1
(43) Pub. Date: Feb. 24, 2005

(54) Method and apparatus for providing media communication setup strategy in a communication network

(76) Inventor: Beth Ann Brewer, La Mesa, CA (US)

Correspondence Address: Qualcomm Incorporated;Patents Department, 5775 Morehouse Drive, San Diego, CA, 92121-1714, US

(21) Appl. No.: 10/646,487

(22) Filed: Aug. 22, 2003

(51) Int. Cl. H04B 7/216

(52) U.S. Cl. 370/335

(57) ABSTRACT

The disclosed embodiments provide methods and apparatus for providing group communication setup strategy for media communication to a group of users operating on diverse infrastructures in a wireless communication network. The method provides receiving a request from an originator for media communication, determining types of infrastructures on which the originator and targets are operating on, and providing a group communication setup strategy for the originator based on the determined types of the infrastructures.

### FIELD

The present invention relates to point to point or point to multi-point communications systems. More specifically, the present invention relates to methods and apparatus for providing uniform media communication setup strategy for a group of users operating on different infrastructures within a group wireless communication network.

### BACKGROUND

A class of wireless services intended for quick, efficient, one-to-one or one-to-many (group) communication has existed in various forms for many years. In general, these services have been half-duplex, where a user presses a “push-to-talk” (PTT) button on a phone/radio to initiate a group communication. If granted the floor, the talker then generally speaks for a few seconds. After the talker releases the PTT button, other users who are available may request the floor. These services have traditionally been used in applications where one person needs to communicate with a group of people, such as field service personnel or taxi drivers, generally known as group communication services.

The members of a group communication session may operate on different types of wireless infrastructures, which may have different setup time requirements. One requirement of group communication services is to provide uniform media communication setup time regardless of the types or versions of infrastructures the group members are operating on.

There is a need, therefore, for mechanisms to selectively provide uniform media communication setup strategy for a group of users operating on different infrastructures in a group wireless communication network.

### SUMMARY

The disclosed embodiments provide novel and improved methods and apparatus for providing group media communication to a group of users operating on diverse infrastructures in a wireless communication network. In one aspect, the method and apparatus provides for: receiving a request from an originator for media communication to at least one target, determining the types of infrastructures on which the originator and the target are operating on, and providing a group media communication setup strategy for the originator based on the determined types of the infrastructures.

In one aspect, the methods and apparatus provides for: allowing an originator to start media communication to a group of users operating on diverse infrastructures in a wireless communication network. The methods and apparatus provides for receiving an indication from an originator desiring to communicate media to at least one target, sending a request to a group communication server, receiving a group media communication setup strategy from the group communication server based on types of infrastructures on which the originator and the target are operating on, and allowing the originator to start communicating media based on the received group media communication setup strategy.

In one aspect, an apparatus for providing group communication setup strategy includes a memory unit, a receiver, a transmitter, and a processor communicatively coupled with the memory unit, the receiver, and the transmitter. The processor is capable of carrying out the above-mentioned methods.

### BRIEF DESCRIPTION OF THE DRAWINGS

The features and advantages of the present invention will become more apparent from the detailed description of the embodiments set forth below:

FIG. 1 illustrates a group communications system;

FIG. 2 illustrates how several communication devices interact with a group communication server;

FIG. 3 illustrates one embodiment for implementing a wireless communications infrastructure;

FIG. 4 illustrates a flow diagram for an optimistic media communication setup strategy for a first type of infrastructure;

FIG. 5 illustrates a flow diagram for a guaranteed media communication setup strategy for a first type of infrastructure;

FIG. 6 illustrates a flow diagram for an optimistic media communication setup strategy for a second type of infrastructure; and

FIG. 7 illustrates a flow diagram for a guaranteed media communication setup strategy for the second type of infrastructure.

### DETAILED DESCRIPTION

Before several embodiments are explained in detail, it is to be understood that the scope of the invention should not be limited to the details of the construction and the arrangement of the components set forth in the following description or illustrated in the drawings. Also, it is to be understood that the phraseology and terminology used herein is for the purpose of description and should not be regarded as limiting.

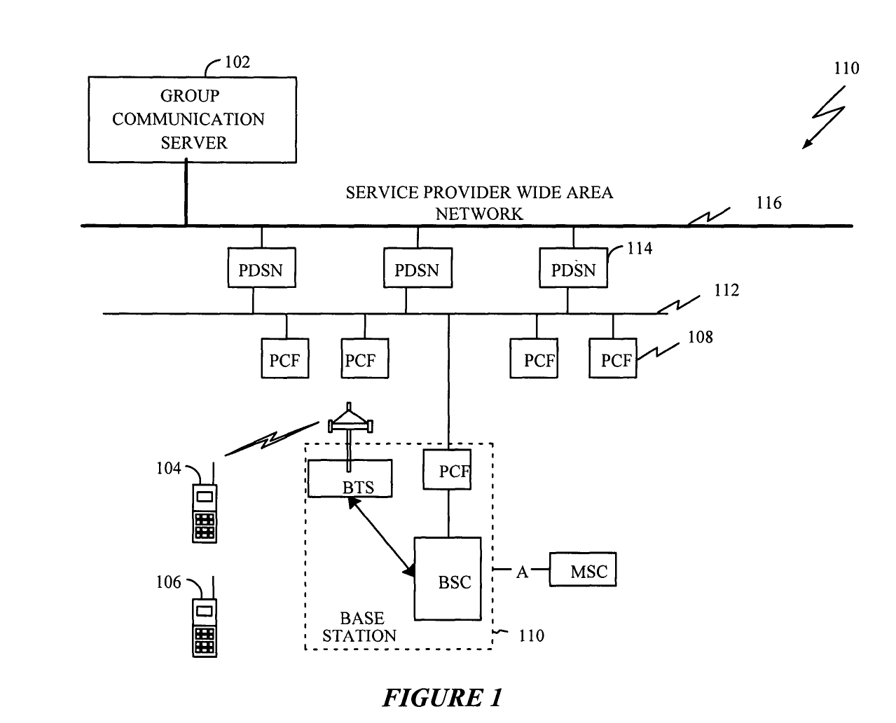

FIG. 1 illustrates a functional block diagram of a group communication system 100, for implementing one embodiment. Group communication system 100 is also known as a push-to-talk (PTT) system, a net broadcast service (NBS), a dispatch system, or a point-to-multi-point communication system. In one embodiment, group communication system 100 includes a group communication server 102, which may be deployed in either a centralized deployment or a regionalized deployment.

Group communication devices (CDs) 104 and 106, which may be deployed such as CDMA (e.g., cdma2000) handsets, for example, may request packet data sessions using a data service option. Each CD may use the session to register its Internet Protocol (IP) address with the group communication server to perform group communication initiations. In one embodiment, group communication server 102 is connected to the service provider's packet data service nodes (PDSNs) through service provider's network 116. CDs 104 and 106, upon requesting packet data sessions from the wireless infrastructure, may have IP connectivity to group communication server 102 through the PDSNs 114. Each PDSN may interface to a base station controller (BSC) through a packet control function (PCF) 108 and a network 112. The PCF may be co-located with the BSC within a base station (BS) 110.

A packet data service node may fall in one of several states, e.g., active or connected state, dormant state, and null or inactive state. In the active or connected state, a active traffic channel exists between the participating CD and the BS or BSC, and either side may send data. In the dormant state, no active traffic channel exists between the participating CD and the BSC, but a point-to-point protocol (PPP) link is maintained between the participating CD and the PDSN. In the null or inactive state, there is no active traffic channel between the participating CD and the BSC, and no PPP link is maintained between the participating CD and the PDSN.

Each one of CDs 104 and 106 may request packet data sessions. As part of establishing a packet data session, each CD may be assigned an IP address. Each CD may perform a registration process to notify group communication server 102 of the CD's IP address. Registration may be performed using an IP protocol, such as session initiation protocol (SIP) over user datagram protocol (UDP). The IP address of a CD may be used to contact the CD when the corresponding user is invited into or informed of a group communication.

Once a group communication is established, CDs 104 and 106 and group communication server 102 may exchange media and signaling messages. In one embodiment, media may be exchanged between the participating CDs and the group communication server by using real-time protocol (RTP) over UDP. The signaling messages may also be exchanged by using a signaling protocol over UDP.

Group communication system 100 performs several different functions in order to operate group communication services. The functions that relate to the user side include user registration, group communication initiation, group communication termination, sending messages to group participants, late join to a group communication, talker arbitration, adding members to a group, removing members from a group, un-registering a member, and authentication. The functions that relate to system preparation and operation include administration and provisioning, scalability, and reliability.

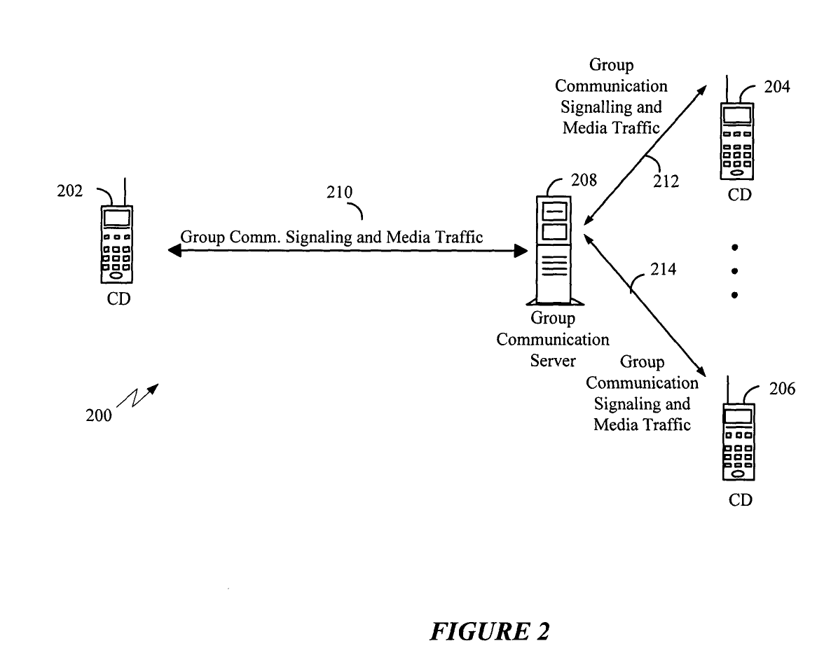

FIG. 2 illustrates a group communication arrangement 200 for showing how CDs 202, 204, and 206 interact with a group communication server 208. Multiple group communication servers may be deployed as desired for large-scale groups. A user may input her desire to a CD 202, 204, 206 to initiate a communication session for exchanging communication media, e.g., data, voice, image, and/or video, with one or more CDs. In one embodiment, the user may first invite the target users(s) before starting to communicate media, by pushing an “invite” or a PTT button on a CD.

In FIG. 2, when CD 202 has permission to transmit media to other members of the group, CD 202 is known as the originator and may transmit media over an established channel. When CD 202 is designated as the originator, the remaining participants, CD 204 and CD 206, may not be permitted to transmit media to the group.

Accordingly, CD 204 and CD 206 are designated as targets. As described above, CDs 202, 204, and 206 are connected to group communication server 208, using at least one channel. In one embodiment, channels 210, 212, and 214 may include a session initiation protocol (SIP) channel, a media-signaling channel, and a media traffic channel.

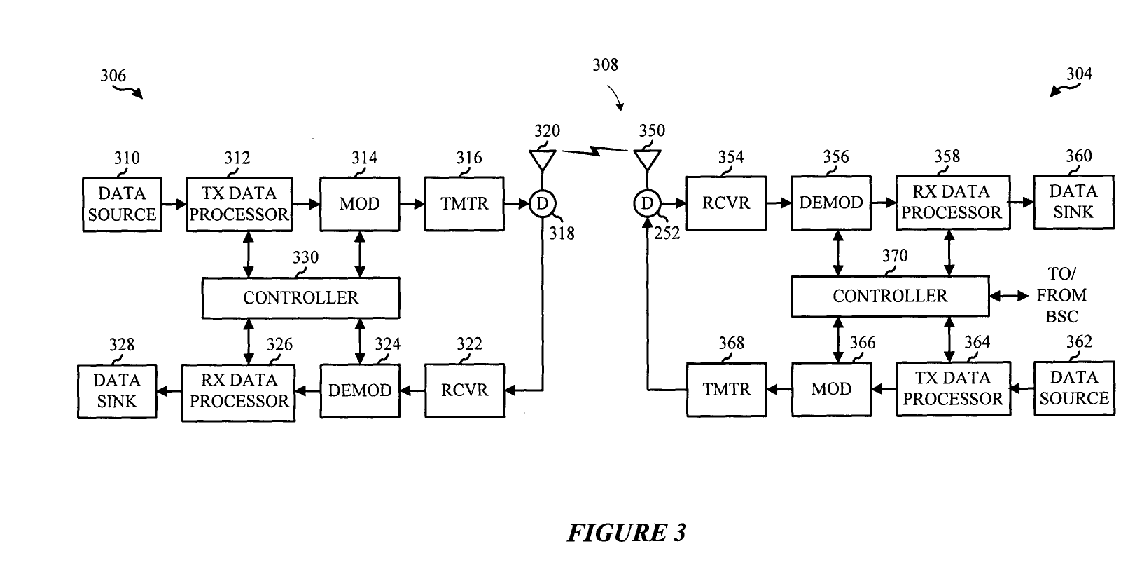

FIG. 3 is a simplified block diagram of an embodiment of a base station/base station controller (BS/BSC) 304 and a communication device 306, which are capable of implementing various disclosed embodiments. For a particular media communication, voice, data, packet data, and/or alert messages may be exchanged between BS/BSC 304 and communication device 306, via an air interface 308. Various types of messages may be transmitted, such as messages used to establish a communication session between the base station and the communication device, registration and paging messages, and messages used to control a data transmission (e.g., power control, data rate information, acknowledgment, and so on). Some of these message types are described in further detail below.

For the reverse link, at communication device 306, voice and/or packet data (e.g., from a data source 310) and messages (e.g., from a controller 330) are provided to a transmit (TX) data processor 312, which formats and encodes the data and messages with one or more coding schemes to generate coded data. Each coding scheme may include any combination of cyclic redundancy check (CRC), convolutional, turbo, block, and other coding, or no coding at all. The voice, packet data, and messages may be coded using different schemes, and different types of messages may be coded differently.

The coded data is then provided to a modulator (MOD) 314 and further processed (e.g., covered, spread with short PN sequences, and scrambled with a long PN sequence assigned to the communication device). The modulated data is then provided to a transmitter unit (TMTR) 316 and conditioned (e.g., converted to one or more analog signals, amplified, filtered, and quadrature modulated) to generate a reverse link signal.

The reverse link signal is routed through a duplexer (D) 318 and transmitted via an antenna 320 to BS/BSC 304.

At BS/BSC 304, the reverse link signal is received by an antenna 350, routed through a duplexer 352, and provided to a receiver unit (RCVR) 354. Alternatively, the antenna may be part of the wireless operator network, and the connection between the antenna and the BS/BSC may be routed through the Internet. BS/BSC 304 may receive media information and alert messages from communication device 306. Receiver unit 354 conditions (e.g., filters, amplifies, down converts, and digitizes) the received signal and provides samples. A demodulator (DEMOD) 356 receives and processes (e.g., despreads, decovers, and pilot demodulates) the samples to provide recovered symbols.

Demodulator 356 may implement a rake receiver that processes multiple instances of the received signal and generates combined symbols. A receive (RX) data processor 358 then decodes the symbols to recover the data and messages transmitted on the reverse link. The recovered voice/packet data is provided to a data sink 360 and the recovered messages may be provided to a controller 370. Controller 370 may include instructions for receiving and sending information, receiving and sending responses to messages, identifying the targets, locating the targets, determining the types of infrastructures the originator and the targets are operating on, determining whether the targets are registered in the group communication system and/or whether at least one target accepts to receive media, providing a setup strategy for the originator, and buffering media. The processing by demodulator 356 and RX data processor 358 are complementary to that performed at remote access device 306. Demodulator 356 and RX data processor 358 may further be operated to process multiple transmissions received via multiple channels, e.g., a reverse fundamental channel (R-FCH) and a reverse supplemental channel (R-SCH). Also, transmissions may be simultaneously from multiple communication devices, each of which may be transmitting on a reverse fundamental channel, a reverse supplemental channel, or both.

On the forward link, at BS/BSC 304, voice and/or packet data (e.g., from a data source 362) and messages (e.g., from controller 370) are processed (e.g., formatted and encoded) by a transmit (TX) data processor 364, further processed (e.g., covered and spread) by a modulator (MOD) 366, and conditioned (e.g., converted to analog signals, amplified, filtered, and quadrature modulated) by a transmitter unit (TMTR) 368 to generate a forward link signal. The forward link signal is routed through duplexer 352 and transmitted via antenna 350 to remote access device 306. Forward link signals include paging signals.

At communication device 306, the forward link signal is received by antenna 320, routed through duplexer 318, and provided to a receiver unit 322. Receiver unit 322 conditions (e.g., down converts, filters, amplifies, quadrature modulates, and digitizes) the received signal and provides samples. The samples are processed (e.g., despreaded, decovered, and pilot demodulated) by a demodulator 324 to provide symbols, and the symbols are further processed (e.g., decoded and checked) by a receive data processor 326 to recover the data and messages transmitted on the forward link. The recovered data is provided to a data sink 328, and the recovered messages may be provided to controller 330. Controller 330 may include instructions for receiving and sending information, receiving and sending responses to messages, providing the type of infrastructures a communication device is operating on, buffering media, transmitting media to a group communication server, and granting permission to the originator to deliver media.

One requirement of group media communication services is to provide optimal media communication setup time regardless of the types or versions of underlying wireless infrastructures. The performance of such systems is measured based on Push-to-Talk (PTT) latency and End-to-End Media Latency. PTT latency includes the delay that is realized from the time an originator presses the PTT button on her or his CD to initiate media communication with one or a group of targets and the time the originator receives an indication that the group communication server has granted the originator permission to send media. End-to-end media latency is the delay that is realized between the time the originator begins to deliver media and the time the target(s) receives the originator's media.

PTT latency includes the delays involved in establishing a communication link between the originator and the group communication server, processing the originator's request for floor, determining the types of the wireless infrastructures each member of the group is operating on, determining a media communication setup strategy, and granting the originator permission to deliver media. The group communication server makes the determination of call set up strategy using one of at least two different methods: guaranteed setup strategy or optimistic setup strategy. In guaranteed setup strategy, the server announces the group media communication to the target(s) specified in the floor request and waits to receive acceptance from at least one target to participate in the group call prior to establishing the group communication and granting permission to the originator to deliver media. In optimistic setup strategy, the server establishes the group communication and grants the originator permission to deliver media after the group communication server has confirmed that the target(s) have a valid registration within the group call system, but prior to contacting the target(s) to confirm their acceptance to participate in the group media communication.

PTT Latency

To reduce PIT latency, the group communication signaling, such as messages and/or responses, floor-control requests, floor-control announcements, and dormancy wakeup messages, may be transmitted on some available common channels. This eliminates waiting for dedicated traffic channels of the dormant CD to be re-established. Common channels may be always available, regardless of the state of the participating CDs, and may not require being requested and reassigned each time a group member initiates a group communication. Therefore, the group communication signaling messages may be exchanged even when the participating CDs are dormant. In one embodiment dedicated traffic channels for the originator's CD and targets' CDs may be re-established in parallel.

In one embodiment, a dormant user A's CD may send a message to the wireless infrastructure over some available reverse common channel, such as reverse access channel and reverse enhanced access channel. The user A's CD may also receive a message on some available forward common channel, such as forward paging channel and forward common control channel. In one embodiment, dormant target CDs may receive dormancy wakeup messages and/or messages on some available forward common channel, such as forward paging channel and forward common control channel.

Short Data Burst Call-Signaling Messages

In one embodiment, a significant reduction in dormancy wakeup time, and hence in PTT latency, may be achieved through the use of short data burst (SDB) messages, as provided in “TIA/EIA/IS-2000 Standards for cdma2000 Spread Spectrum Systems,” hereinafter referred to as “the cdma2000 standard.” In one embodiment, SDB messages may be sent over a dedicated active channel, such as the forward fundamental channel (FCH) or forward dedicated common control channel (F-DCCH). SDB messages may also be sent over a common active channel, such as the reverse access channel (R-ACH), reverse enhanced access channel (R-EACH), forward common control channel (F-CCCH), or paging channel (PCH). SDB messages may be transported by radio burst protocol (RBP), which maps the messages onto an appropriate and available active layer channel. Because SDB messages may carry arbitrary IP traffic and may be sent over common active channels, SDB messages provide a mechanism to exchange group communication signaling when participating CDs have no available dedicated traffic channel.

In one embodiment, media-signaling messages may carry IP datagrams over the reverse link or mobile-originated link. An originator's communication device may signal the group communication server quickly whenever the originator requests the floor and a dedicated reverse traffic channel is not immediately available. Assuming the originator's CD has released all dedicated traffic channels, the originator's CD may immediately forward the floor-request message over a reverse common channel of a wireless infrastructure, which may relay the floor-request message to the group communication server. For example, either the reverse access channel or the reverse enhanced access channel may be used to send such messages when a dedicated reverse channel is not available. In one embodiment, the originator's CD may transmit a floor-request message to the group communication server as SDB messages.

The choice of guaranteed setup strategy or optimistic setup strategy depends on the capability of the CDs and/or the types of the infrastructures, e.g., different releases of the CDMA infrastructure, on which the CDs are operating on. For example, when an originator's CD, which is capable of SDB messaging, operates on “type II” infrastructure, which supports SDB messaging, occasionally roams into a “type I” infrastructure, which does not support SDB messaging, the PTT latency is impacted by the originator's traffic channel re-origination time when the roaming originator requests a group communication session with one or a group of targets. In this case, while either optimistic or guaranteed setup strategy may be used, optimistic setup strategy would result in a shorter PTT latency. By choosing an optimum setup strategy, service providers may provide a uniform communication setup experience when users move among different infrastructures and/or the users operate communication devices of different capabilities.

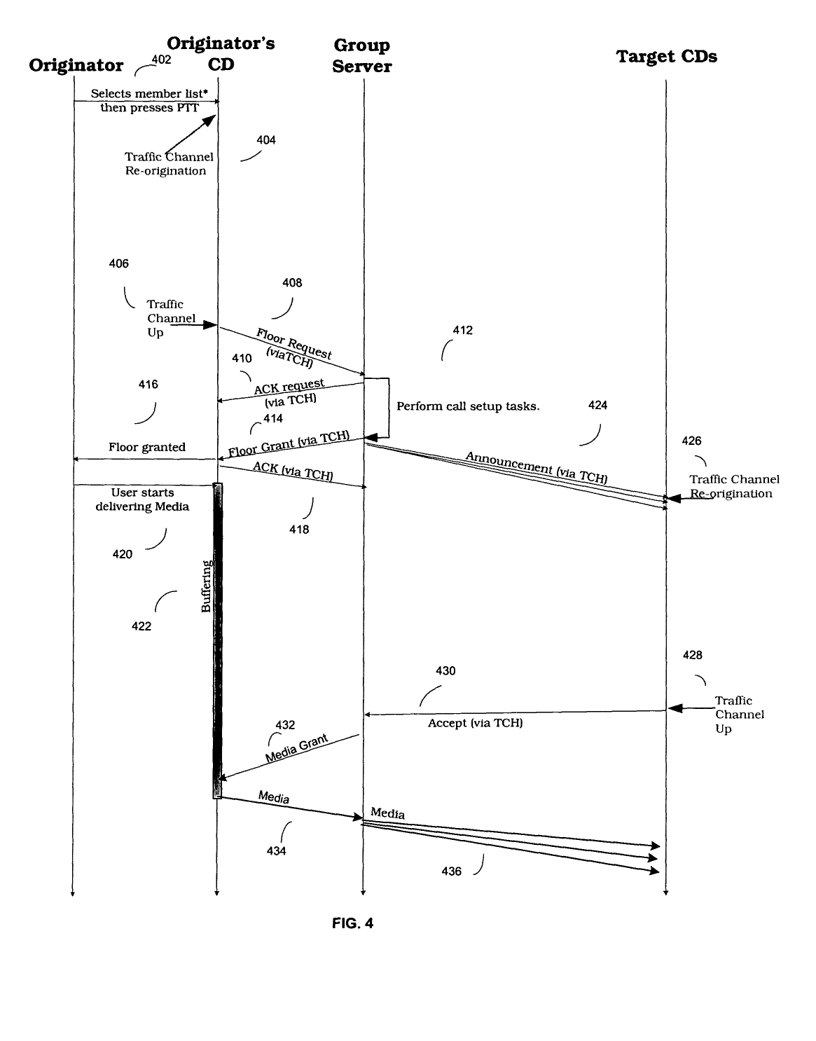

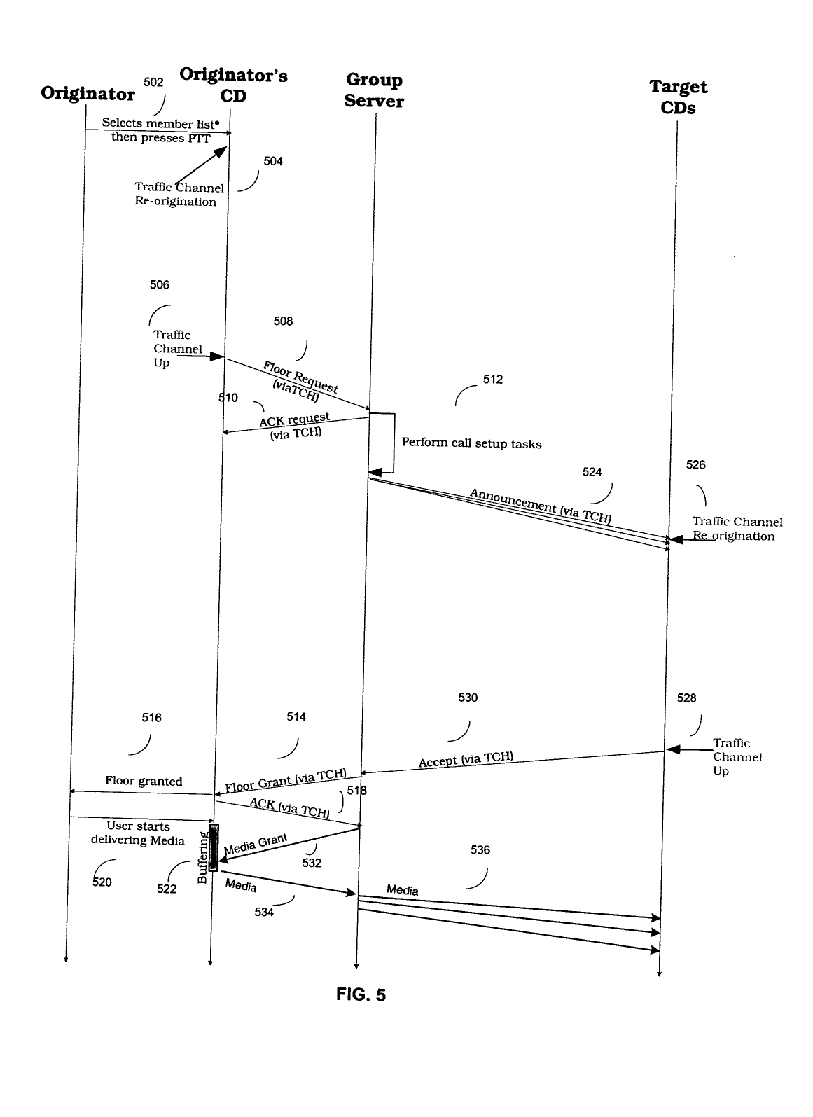

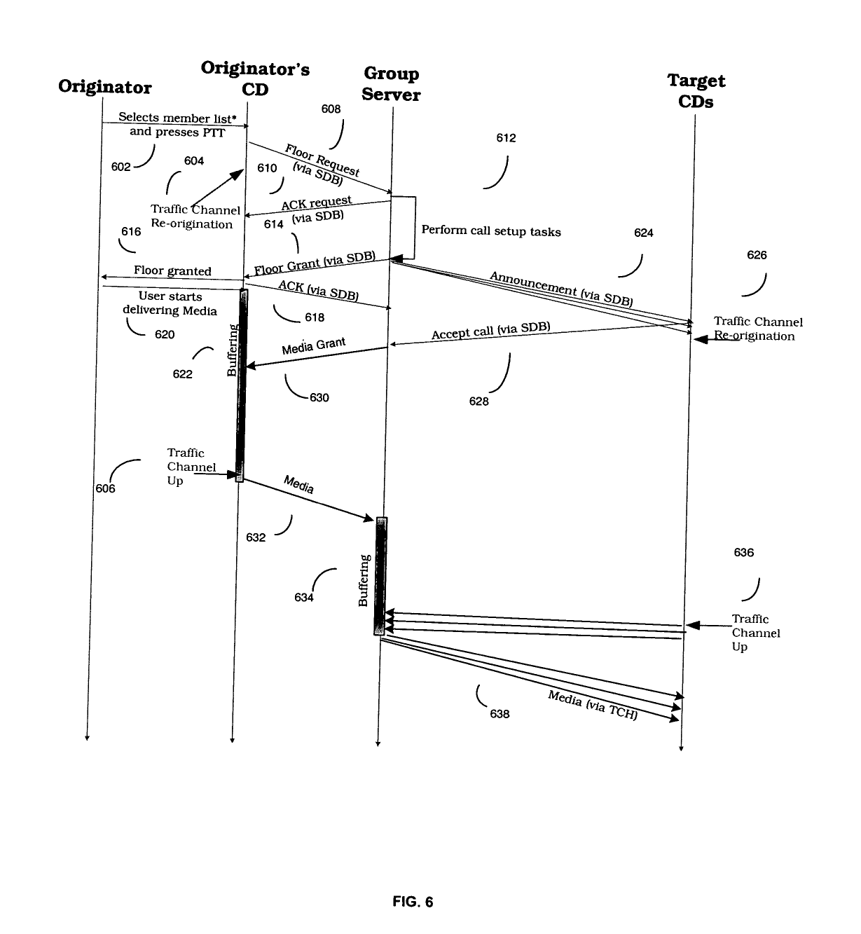

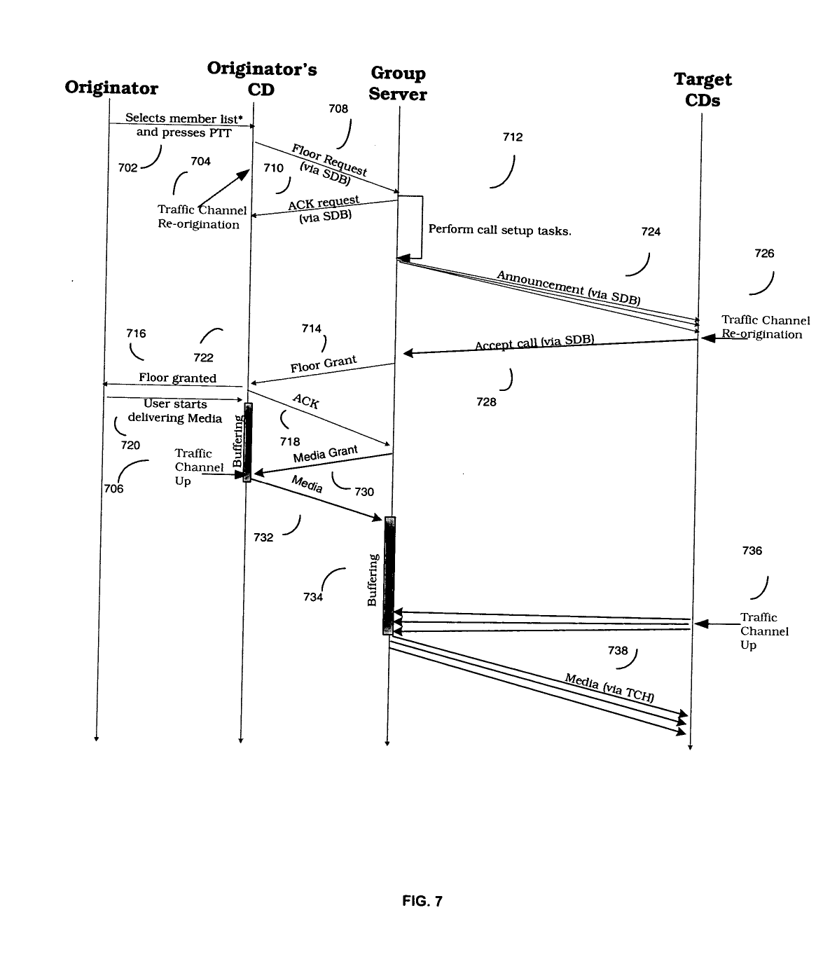

FIG. 4 and FIG. 5 illustrate optimistic group communication setup strategy and guaranteed group communication setup strategy, respectively, for an ad-hoc group communication where the originator and targets are operating on type I infrastructure, e.g., “Release 0” of the CDMA infrastructure. FIG. 6 and FIG. 7 illustrate optimistic group communication setup strategy or guaranteed group setup communication strategy, respectively, for an ad-hoc group communication where the originator and targets are operating on type II infrastructure, e.g., “Release A” of the CDMA infrastructure.

FIG. 4 illustrates a flow diagram showing a process for providing a group communication setup strategy, according to one embodiment. A group communication originator user may set up a communication session for communicating media, such as data, text, formatted document, voice, image, and/or video, to a single or a group of target users. The originator who wishes to initiate the communication session for sending media may select one or more target users, one or more pre-defined groups of target users, or a combination of the two, and press a button, such as a push-to-talk (PTT) button, on his or her CD. The originator may need to wait until a communication session is established and receives permission to start delivering media, based on the type of the infrastructure the originator is operating on.

In FIG. 4, the originator's CD receives an indication from the originator for setting up a session to communicate media to one or a group of targets, in step 402. In this embodiment, the originator is operating on type I infrastructure, which does not support SDB messaging. Therefore, the originator's CD may need to set up its traffic channel prior to sending a message to the group communication server. Upon receiving the indication from the originator, the originator's CD starts the process of traffic channel re-origination, in step 404, and waits until the traffic channel for the originator is up, in step 406.

The originator's CD then sends a “floor request” message, in step 408, to a group communication server for floor control. The group communication server sends an “ACK request” to the originator's CD, in step 410, acknowledging the receipt of the floor request. The group communication server performs group communication setup tasks including: identifying the targets, locating the targets, determining the types of infrastructures the originator and the targets are operating on, and determining whether the targets are registered in the group communication system and/or whether at least one target accepts to receive media.

In one embodiment, the group communication server determines the types of the infrastructure supporting a CD based on inputs provided by the CD. The CD may provide information identifying the supporting infrastructure during registration process. For example, the CD provides a flag in its registration. The flag indicates whether the infrastructure and the CD are type I, meaning that they do not support SDB, or type II, meaning that they both support SDB. The CD may learn the infrastructure's type during registration process, e.g., via the P-REV parameter in CDMA registration.

In this embodiment, the group communication server determines that the originator is operating on type I infrastructure, which does not support SDB messaging.

The group communication server employs optimistic group communication setup strategy, where the group communication server determines whether the targets are registered in the group communication system. In step 414, after the group communication server has determined that at least one of the targets is registered, the group communication server sends a “floor grant” message to the originator's CD.

The originator's CD sends a “floor granted” message to the originator, in step 416, indicating that the requested group communication session has been established, floor has been granted and the originator start delivering media, e.g., start talking. If, at this time, the originator has released the PTT button, the originator may press PTT button again to start delivering media, e.g., start talking. The originator's CD also sends an “ACK” message to the group communication server, in step 418, acknowledging the receipt of the “floor grant” message.

In one embodiment, the originator's CD receives media delivered by the originator, in step 420, and buffers the received media, in step 422, for transmission to the group communication server after the traffic channels of the target CDs have been re-established.

The group communication server, after identifying the targets in step 412, sends “announcements” messages, in step 424, to the infrastructures supporting the target CDs, to trigger re-origination of the traffic channels for the target CDs. In one embodiment, the group communication server sends the “announcements” messages to the IP address associated with each target. Each infrastructure, e.g., PDSN/CDMA, recognizes the corresponding target's traffic channels is in the dormant state, so the infrastructure starts the process of re-originating the corresponding traffic channel in order to deliver the “announcement” message thereto. The target CDs' infrastructures start re-originating the targets' traffic channels, in step 426. After the traffic channels of the target CDs are up, in step 428, and at least one target has accepted to receive media from the originator, in step 430, the group communication server sends a media grant message, in step 432, to the originator's CD.

After receiving the “media grant” message from the group communication server, the originator's CD starts transferring media, which may have been buffered in step 422, to the group communication server, in step 434. The group communication server then transmits, in step 436, the received media to the target CDs that have active traffic channel. In this embodiment, the PTT latency for optimistic setup strategy is impacted by the traffic channel re-origination time for the originator, since the group communication server does not need to contact the targets prior to granting permission to the originator to start delivering media.

FIG. 5 illustrates a flow diagram showing a process for providing a group communication set up strategy, according to one embodiment. The originator's CD receives an indication from the originator for setting up a session to communicate media to one or a group of targets, in step 502. In this embodiment, the originator is operating on type I infrastructure, which does not support SDB messaging. Therefore, the originator's CD may need to set up its traffic channel prior to sending a message to the group communication server. Upon receiving the indication from the originator, the originator's CD starts the process of traffic channel re-origination, in step 504, and waits until the traffic channel for the originator is up, in step 506.

The originator's CD then sends a “floor request” message, in step 508, to the group communication server for floor control. The group communication server sends an “ACK request” to the originator's CD, in step 510, acknowledging the receipt of the floor request. The group communication server then performs group communication setup tasks, in step 512, including identifying the targets, locating the targets, determining the types of infrastructures the originator and the targets are operating on, and determining whether the targets are registered in the group communication system and/or whether at least one target accepts to receive media.

In this embodiment, the group communication server determines that the originator is operating on type I infrastructure, which does not support SDB messaging.

The group communication server employs guaranteed group communication setup strategy, where the group communication server determines whether at least one target will accept to receive media. Accordingly, the group communication server sends announcements, in step 524, to the infrastructures supporting the target CDs, to trigger re-origination of the traffic channels for the target CDs. The target CDs' infrastructures start re-originating the targets' traffic channels, in step 526.

After the traffic channels of the target CDs are up, in step 528, and at least one target has accepted to receive media from the originator, in step 530, the group communication server sends a “floor grant” message, in step 514, to the originator's CD. The Originator's CD sends a “floor granted” message to the originator, in step 516, indicating that the requested group communication session has been established, floor has been granted and the originator may start delivering media, e.g., start talking. If, at this time, the originator has released the PTT button, the originator may press PTT button again to start delivering media, e.g., start talking. The Originator's CD also sends an “ACK” message to the group communication server, in step 518, acknowledging the receipt of the “floor grant” message.

In one embodiment, the originator's CD receives media delivered by the originator, in step 520, and buffers the received media in step 522 for transmission to the group communication server, after receiving order from the group communication server.

After receiving “media grant” message, in step 532, from the group communication server, the originator's CD starts transferring media, which may have been buffered as in step 522, to the group communication server. The group communication server then transmits, in step 536, the received media to the target CDs that have active traffic channel.

In this embodiment, the PTT latency for optimistic setup strategy is impacted by the traffic channel re-origination time for the originator and the targets, since the group communication server contacts the targets prior to granting permission to the originator to start delivering media. Therefore, the PIT latency is longer than the PTT latency for the embodiment described above in connection with FIG. 4.

FIG. 6 illustrates a flow diagram showing a process for providing a group media communication setup strategy, according to one embodiment. The originator's CD receives an indication for setting up a session to communicate media to one or a group of targets, in step 602. In this embodiment, the originator is operating on type II infrastructure, which supports SDB messaging. Therefore, the originator's CD does not need to wait for its traffic channel to be set up before being able to send or receive messages. Upon receiving the indication from the originator, the originator's CD starts the process of traffic channel re-origination, in step 604, but does not need to wait until the traffic channel for the originator's infrastructure is up, in step 406, before being able to send or receive messages to or from the group communication server. In one embodiment, the originator's CD sends such messages in SDB form, as discussed above.

The originator's CD, sends a “floor request” message, in step 608, via SDB, to the group communication server for floor control. The group communication server sends an “ACK request” message to the originator's CD, in step 610, via SDB, acknowledging the receipt of the floor request. The group communication server then performs group communication setup tasks, in step 612, including identifying the targets, locating the targets, determining the types of infrastructures the originator and the targets are operating on, and determining whether the targets are registered in the group communication system and/or whether at least one target accepts to receive media.

In this embodiment, the group communication server determines that the originator and the targets are operating on type II infrastructures, which support SDB messaging. The group communication server employs optimistic group communication setup strategy, where the group communication server determines whether the targets are registered in the group communication system. In step 614, after the group communication server has determined that at least one of the targets is registered, the group communication server sends a “floor grant” message, via SDB, to the originator's CD. The originator's CD sends a “floor granted” message, in step 616, indicating that the requested group communication session has been established, floor has been granted, and the originator may start delivering media, e.g., start talking. If the originator has released the PTT, the originator may press PTT again to start delivering media, e.g., start talking. The originator's CD also sends an “ACK” message, via SDB, to the group communication server, in step 618, acknowledging the receipt of the “floor grant” message.

In one embodiment, the originator's CD receives media delivered by the originator, in step 620, and buffers the received media, in step 622, for transmission to the group communication server, after the traffic channels of the originator's CD is re-established.

After identifying and locating the targets, the group communication server sends announcements, in step 624, to the target CDs' infrastructures to inform them of an upcoming media communication. The announcement may be sent via SDB. The target CDs' infrastructures start re-originating their traffic channels, in step 626. After the group communication server receives at least one acceptance message from the originator, in step 628, via SDB, the group communication server sends a “media grant” message, in step 630, via SDB or traffic channel, to the originator's CD.

After the traffic channel of the originator's CD is up, in step 606, the originator's CD starts transferring media, which may have been buffered in step 622, to the group communication server. The group communication server may also buffer the received media, in step 632, for transmission to the targets, after the traffic channels of the targets are re-established. After receiving an indication that the traffic channels of the targets are re-established, in step 636, the group communication server then transmits, in step 638, the received media to the target CDs that have active traffic channel.

In this embodiment, the PTT latency for optimistic setup strategy is not impacted by the traffic channel re-origination time for the originator, since the group communication server does not need to wait for the originator's traffic channel re-origination prior to being able to send messages to the group communication server. Therefore, the PTT latency is shorter than the PTT latency for the embodiment described above in connection with FIG. 4.

FIG. 7 illustrates a flow diagram showing a process for providing a group communication setup strategy, according to one embodiment. The originator's CD receives an indication for setting up a session to communicate media to one or a group of targets, in step 702. The originator's CD starts the process of traffic channel re-origination, in step 704, but does not need to wait until the traffic channel for the originator's infrastructure is up, in step 706, before being able to send or receive messages to or from the group communication server. In one embodiment, the originator's CD sends such messages in SDB form, as discussed above.

The originator's CD, sends a “floor request,” in step 708, via SDB, to the group communication server for floor control. The group communication server sends an “ACK request” to the originator's CD, in step 710, via SDB, acknowledging the receipt of the floor request. The group communication server performs group communication setup tasks, in step 712, including identifying the targets, locating the targets, determining the types of infrastructures the originator and the targets are operating on, and determining whether the targets are registered and/or whether at least one target accepts to receive media.

In this embodiment, the group communication server determines that the originator and the targets are operating on type II infrastructure, which supports SDB messaging as discussed above. The group communication server employs guaranteed call set up strategy, where the group communication server determines whether at least one target will accept to receive media from the originator. Therefore, the group communication server sends announcements, in step 724, to the target CDs to inform them of an upcoming media communication. The announcement may be sent via SDB. After the group communication server receives at least one acceptance message from the originator, in step 728, via SDB, the group communication server sends a “floor grant” message, in step 714, via SDB, to the originator's CD.

The originator's CD sends a “floor granted” message to the originator, in step 716, indicating that the requested group communication session has been established, floor has been granted and the originator may start delivering media, e.g., start talking.

The originator's CD also sends an “ACK” message via SDB to the group communication server, in step 718, acknowledging the receipt of the floor grant message.

In one embodiment, the originator's CD receives media delivered by the originator, in step 720, and buffers the received media, in step 722, for transmission to the group communication server, after the traffic channels of the originator's is re-established.

After receiving the ACK message, in step 718, the group communication server sends a “media grant” message, via SDB or traffic channel, in step 730, to the originator's CD. After the traffic channel of the originator's CD is up, in step 706, the originator's CD starts transferring media that may have been buffered as in step 722, to the group communication server, in step 732. The group communication server may also buffer the received media, in step 734, for transmission to the targets, after the traffic channels of the targets are re-established. After the traffic channels of the targets are re-established, in step 736, the group communication server then transmits, in step 738, the received media to the target CDs that have active traffic channel.

In this embodiment, the PIT latency for guaranteed setup strategy is not impacted by the traffic channel re-origination time for the originator and the targets, since the group communication server does not need to wait for the traffic channel re-origination prior to being able to send or receive messages to or from the CDs. Therefore, the PTT latency is shorter than the PTT latency for the embodiment described above in connection with FIG. 4, but longer than the PTT latency for the embodiment described above in connection with FIG. 6. Consequently, based on the types of the originator and the targets' infrastructures, either optimistic or guaranteed setup strategy may be selectively chosen to provide a uniform setup experience for a group of users operating on diverse infrastructures.

Those of skill in the art would understand that information and signals may be represented using any of a variety of different technologies and protocols. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The description of the disclosed embodiments is provided to enable any person skilled in the art to make or use the present invention. Various modifications to these embodiments may be readily apparent to those skilled in the art, and the generic principles defined herein may be applied to other embodiments, e.g., in an instant messaging service or any general wireless data communication applications, without departing from the spirit or scope of the invention. Thus, the present invention is not intended to be limited to the embodiments shown herein but is to be accorded the widest scope consistent with the principles and novel features disclosed herein. The word “exemplary” is used exclusively herein to mean “serving as an example, instance, or illustration.” Any embodiment described herein as “exemplary” is not necessarily to be construed as preferred or advantageous over other embodiments.

1. A method for providing group media communication to a group of users operating on diverse infrastructures in a wireless communication network, the method comprising:
receiving a request from an originator for media communication to at least one target;
determining a type of infrastructure on which the originator is operating on;
determining a type of infrastructure on which the target is operating on; and
providing a group media communication setup strategy for the originator based on the determined types of the infrastructures.

2. The method of claim 1, wherein said receiving includes receiving information identifying the type of the infrastructure on which the originator is operating on.

3. The method of claim 1, wherein said determining includes determining whether the types of infrastructures includes code division multiple access (CDMA) infrastructure.

4. The method of claim 3, wherein said determining includes determining whether the types of infrastructures includes different versions of the CDMA infrastructure.

5. The method of claim 4, wherein the different versions of the CDMA infrastructure includes “Release 0” and “Release A” of the CDMA infrastructure.

6. The method of claim 1, wherein said providing includes providing an optimistic setup strategy.

7. The method of claim 1, wherein said providing includes providing a guaranteed setup strategy.

8. An apparatus for providing group media communication to a group of users operating on diverse infrastructures in a wireless communication network, comprising:
means for receiving a request from an originator for media communication to at least one target;
means for determining a type of infrastructure on which the originator is operating on;
means for determining a type of infrastructure on which the target is operating on; and
means for providing a group media communication setup strategy for the originator based on the determined types of the infrastructures.

9. The apparatus of claim 8, wherein the request includes information identifying the type of the infrastructure on which the originator is operating on.

10. The apparatus of claim 8, wherein the types of infrastructures includes code division multiple access (CDMA) infrastructure.

11. The apparatus of claim 10, wherein the types of infrastructures includes different versions of the CDMA infrastructure.

12. The apparatus of claim 11, wherein the different versions of the CDMA infrastructure includes “Release 0” and “Release A” of the CDMA infrastructure.

13. The apparatus of claim 8, wherein the group media communication setup strategy includes an optimistic setup strategy.

14. The apparatus of claim 8, wherein the group media communication setup strategy includes a guaranteed setup strategy.

15. A computer-readable medium embodying codes for implementing a method for providing group media communication to a group of users operating on diverse infrastructures in a wireless communication network, the method comprising:
receiving a request from an originator for media communication to at least one target;
determining a type of infrastructure on which the originator is operating on;
determining a type of infrastructure on which the target is operating on; and
providing a group media communication setup strategy for the originator based on the determined types of the infrastructures.

16. The computer-readable medium of claim 15, wherein said receiving includes receiving information identifying the type of the infrastructure on which the originator is operating on.

17. The computer-readable medium of claim 15, wherein said determining includes determining whether the types of infrastructures includes code division multiple access (CDMA) infrastructure.

18. The computer-readable medium of claim 17, wherein said determining includes determining whether the types of infrastructures includes different versions of the CDMA infrastructure.

19. The computer-readable medium of claim 18, wherein the different versions of the CDMA infrastructure includes “Release 0” and “Release A” of the CDMA infrastructure.

20. The computer-readable medium of claim 15, wherein said providing includes providing an optimistic setup strategy.

21. The computer-readable medium of claim 15, wherein said providing includes providing a guaranteed setup strategy.

22. An apparatus for providing group media communication to a group of users operating on diverse infrastructures in a wireless communication network, comprising:
a memory unit;
a receiver;
a transmitter; and
a processor coupled to the memory unit, the receiver, and the transmitter, the processor being capable of:
receiving a request from an originator for media communication to at least one target;
determining a type of infrastructure on which the originator is operating on;
determining a type of infrastructure on which the target is operating on; and
providing a group media communication setup strategy for the originator based on the determined types of the infrastructures.

23. The apparatus of claim 22, wherein said receiving includes receiving information identifying the type of the infrastructure on which the originator is operating on.

24. The apparatus of claim 22, wherein said determining includes determining whether the types of infrastructures includes code division multiple access (CDMA) infrastructure.

25. The apparatus of claim 24, wherein said determining includes determining whether the types of infrastructures includes different versions of the CDMA infrastructure.

26. The apparatus of claim 25, wherein the different versions of the CDMA infrastructure includes “Release 0” and “Release A” of the CDMA infrastructure.

27. The apparatus of claim 22, wherein said providing includes providing an optimistic setup strategy.

28. The apparatus of claim 22, wherein said providing includes providing a guaranteed setup strategy.

29. A method for allowing an originator to start media communication to a group of users operating on diverse infrastructures in a wireless communication network, the method comprising:
receiving an indication from an originator desiring to communicate media to at least one target;
sending a request to a group communication server;
receiving a group media communication setup strategy from the group communication server based on types of infrastructures on which the originator and the target are operating on; and
allowing the originator to start communicating media based on the received group media communication setup strategy.

30. The method of claim 29, wherein said sending includes sending information identifying the type of the infrastructure on which the originator is operating on.

31. The method of claim 29, wherein said types of infrastructures includes code division multiple access (CDMA) infrastructure.

32. The method of claim 31, wherein said types of infrastructures includes different versions of the CDMA infrastructure.

33. The method of claim 32, wherein the different versions of the CDMA infrastructure includes “Release 0” and “Release A” of the CDMA infrastructure.

34. The method of claim 29, wherein said allowing includes allowing the originator to start communicating media based on an optimistic setup strategy.

35. The method of claim 29, wherein said allowing includes allowing the originator to start communicating media based on a guaranteed setup strategy.

36. An apparatus for allowing an originator to start media communication to a group of users operating on diverse infrastructures in a wireless communication network, comprising:
means for receiving an indication from an originator desiring to communicate media to at least one target;
means for sending a request to a group communication server;
means for receiving a group media communication setup strategy from the group communication server based on types of infrastructures on which the originator and the target are operating on; and
means for allowing the originator to start communicating media based on the received group media communication setup strategy.

37. The apparatus of claim 36, wherein said means for sending includes means for sending information identifying the type of the infrastructure on which the originator is operating on.

38. The apparatus of claim 36, wherein said types of infrastructures includes code division multiple access (CDMA) infrastructure.

39. The apparatus of claim 38, wherein said types of infrastructures includes different versions of the CDMA infrastructure.

40. The apparatus of claim 39, wherein the different versions of the CDMA infrastructure includes “Release 0” and “Release A” of the CDMA infrastructure.

41. The apparatus of claim 36, wherein said means for allowing includes means for allowing the originator to start communicating media based on an optimistic setup strategy.

42. The apparatus of claim 36, wherein said means for allowing includes means for allowing the originator to start communicating media based on a guaranteed setup strategy.

43. A computer-readable medium storing program codes for performing a method for allowing an originator to start media communication to a group of users operating on diverse infrastructures in a wireless communication network, the method comprising:
receiving an indication from an originator desiring to communicate media to at least one target;
sending a request to a group communication server;
receiving a group media communication setup strategy from the group communication server based on types of infrastructures on which the originator and the target are operating on; and
allowing the originator to start communicating media based on the received group media communication setup strategy.

44. The computer-readable medium of claim 43, wherein said sending includes sending information identifying the type of the infrastructure on which the originator is operating on.

45. The computer-readable medium of claim 43, wherein said types of infrastructures includes code division multiple access (CDMA) infrastructure.

46. The computer-readable medium of claim 45, wherein said types of infrastructures includes different versions of the CDMA infrastructure.

47. The computer-readable medium of claim 46, wherein the different versions of the CDMA infrastructure includes “Release 0” and “Release A” of the CDMA infrastructure.
computer-readable medium

48. The computer-readable medium of claim 43, wherein said allowing includes allowing the originator to start communicating media based on an optimistic setup strategy.

49. The computer-readable medium of claim 43, wherein said allowing includes allowing the originator to start communicating media based on a guaranteed setup strategy.

50. An apparatus for allowing an originator to start media communication to a group of users operating on diverse infrastructures in a wireless communication network, comprising:
a memory unit;
a receiver;
a transmitter; and
a processor coupled to the memory unit, the receiver, and the transmitter, the processor being capable of:
receiving an indication from an originator desiring to communicate media to at least one target;
sending a request to a group communication server;
receiving a group media communication setup strategy from the group communication server based on types of infrastructures on which the originator and the target are operating on; and
allowing the originator to start communicating media based on the received group media communication setup strategy.

51. The apparatus of claim 50, wherein said sending includes sending information identifying the type of the infrastructure on which the originator is operating on.

52. The apparatus of claim 50, wherein said types of infrastructures includes code division multiple access (CDMA) infrastructure.

53. The apparatus of claim 52, wherein said types of infrastructures includes different versions of the CDMA infrastructure.

54. The apparatus of claim 53, wherein the different versions of the CDMA infrastructure includes “Release 0” and “Release A” of the CDMA infrastructure.

55. The apparatus of claim 50, wherein said allowing includes allowing the originator to start communicating media based on an optimistic setup strategy.

56. The apparatus of claim 50, wherein said allowing includes allowing the originator to start communicating media based on a guaranteed setup strategy.
